(19) United States
(12) Patent Application Publication
(10) Pub. No.: US 2003/0006658 A1
(43) Pub. Date: Jan. 9, 2003

(54) Ultra-slim structure of disk-spindle motor

(75) Inventors: Gunhee Jang, Seoul (KR); Kyungsu Kim, Gyeongsangnam-do (KR)

Correspondence Address: GREENBLUM & BERNSTEIN, P.L.C., 1941 ROLAND CLARKE PLACE, RESTON, VA, 20191, US

(73) Assignee: Gunhee JANG, Seoul (KR)

(21) Appl. No.: 09/893,669

(22) Filed: Jun. 29, 2001

(51) Int. Cl. H02K 5/16; H02K 7/08; H02K 7/00; H02K 11/00

(52) U.S. Cl. 310/90; 310/67 R

(57) ABSTRACT

An ultra-slim disk-spindle motor includes a cylindrical hub 250 of which both ends are opened, the hub having an inner protruding portion 251 formed along a central portion of an inner circumferential face of the hub and an outer protruding portion 252 formed along an upper side of the outer circumferential face of the hub, an upper ball bearing 242 and a lower ball bearing 241 being fixedly inserted above and below the inner protruding portion 251, a permanent magnet 260 bonded to a lower side of an outer circumferential face of the outer protruding portion 252 of the hub 250, a disk 270 mounted on an upper face of the outer protruding portion 252 of the hub 250 and a clamp 280 fixed with the hub using a bolt 281 and 282 in order to mount the disk 270.

### BACKGROUND OF THE INVENTION

1. Field of the Invention

The present invention relates to an ultra-slim structure of disk-spindle motor, and more particularly, to an ultra-slim disk-spindle motor having a slimmed structure in which an upper end portion of a hub of the spindle motor is removed, the spindle motor being used to drive a disk of a micro drive which is installed as an auxiliary memory device in portable computers.

2. Description of the Related Art

Generally, spindle motors are widely used as a driving source of peripheral devices such as floppy disk drive, hard disk drive, compact disk drive, etc. Recently, use of these spindle motors is being expanded even to a driving source of a micro drive that is installed at a portable computer in accordance with the specification of PCMCIA (Personal Computer Memory Card International Association).

PCMCIA is the international specification for memory cards in order to expand functions through an expansion slot of a portable computer like the slot of a desktop computer, and is classified into three types depending on thickness (unit: mm) of the expansion card.

Expansion card of the type I has a thickness of 3.3 mm and is applied to a RAM (Random Access Memory), flash memory card, etc. Expansion card of the type II has a thickness of 5.0 mm and is applied to a modem, LAN (Local Area Network) card, IO (Input and Output) card, etc. Expansion card of the type III has a thickness of 10.5 mm and is applied to a hard disk drive.

Expansion cards of the types I and II are operated within the slot of the type III and expansion card of the type I is operated even within the slot of the type II. However, it is noted that a thicker card would not be inserted at a thinner slot.

FIG. 1 is a cross sectional view of a disk-spindle motor of a micro drive made in IBM corp. in accordance with the conventional art.

Referring to FIG. 1, a disk-spindle motor includes a base plate 10, a housing 20, a stator 30, a ball bearing 40 and a shaft 50, a hub 60, a permanent magnet 70, a disk 80, a clamp 90 and a cover 100.

The base plate 10 has a circular hole at a central portion of the base plate 10.

The housing 20 is in a shape of ring in which a central portion is penetrated and has a jaw portion along the ring portion thereof. The housing 20 is vertically inserted at the circular hole of the base plate 10 and is fixed.

The stator 30 comprises a tooth-slot structured iron core and a winding wound around the core and is bonded to an outer portion of the jaw portion of the housing 20.

The ball bearing 40 is in a shape of ring in which a hole is formed at a central portion thereof and comprises an inner race, an outer race and multiple balls. The outer race of the ball bearing 40 is bonded to an inner circumferential face of the housing 20.

The shaft 50 is fixedly inserted at the central hole of the ball bearing 40.

The hub 60 is in a hollow cylindrical shape and has a protruding portion at an upper portion of an outer circumferential portion. The hub 60 is formed integrally with the shaft 50 and it is spaced apart by a certain interval from the inner portion of the housing 20.

The permanent magnet 70 is disposed and spaced apart by a certain interval from the stator 30 bonded to the jaw portion of the housing 20 and it is bonded to a lower side of an outer circumferential portion of the protruding portion of the hub 60.

The disk 80 is vertically inserted and mounted on an upper side of the protruding portion of the hub 60.

The clamp 90 is mounted on the upper side of the hub 60 formed integrally with the shaft 50 and is fixed to the shaft 50 using a bolt in order to mount the disk 80.

The cover 100 is fixed to the base plate 10 spaced apart by a certain interval from the upper side of the clamp 90.

However, the above conventional drive is the type II having the thickness of 5.0 mm and has a drawback in that it cannot be installed at an expansion slot of the type I having the thickness of 3.3 mm.

Thus, in order to allow the micro drive to be miniaturized and slimmed, it is preferentially requested to make ultra-thin the disk-spindle motor serving as a driving source of the micro drive.

### SUMMARY OF THE INVENTION

It is, therefore, an object of the present invention to provide an ultra-slim disk-spindle motor of PCMCIA type I by making ultra-thin the spindle motor through removing an upper end portion of the hub of the spindle motor.

To achieve the above object, there is provided an ultra-slim disk-spindle motor comprising: a base plate 200 having a circular hole formed at an inner lower portion of a central part thereof; a housing 210 fixedly inserted into the circular hole of the base plate; a fixed shaft 220 formed integrally with the housing at an upper central portion of the housing 210; a stator 230 bonded to an upper end portion of an inner circumferential face of the circular hole; a lower ball bearing 241 bonded to a lower side of an outer circumferential face of the fixed shaft 220; an upper ball bearing 242 spaced apart by a 0.5 certain interval from the lower ball bearing 241 and bonded to an upper side of the outer circumferential face of the fixed shaft 220; a cylindrical hub 250 of which both ends are opened, the cylindrical hub 250 having an inner protruding portion 251 formed along a central portion of an inner circumferential face of the hub and an outer protruding portion 252 formed along an upper side of the outer circumferential face of the hub, the inner protruding portion 251 being fixedly inserted between the lower ball bearing 241 and the upper ball bearing 242; a permanent magnet 260 bonded to a lower side of an outer circumferential face of the outer protruding portion 252 of the hub 250; a disk 270 mounted on an upper face of the outer protruding portion 252 of the hub 250; and a clamp 280 fixed firmly on the hub using a bolt 281 and 282 in order to mount the disk 270.

### BRIEF DESCRIPTION OF THE DRAWINGS

The above objects, features and advantages of the present invention will be more apparent from the following detailed description when taken in conjunction with the accompanying drawings, in which:

FIG. 1 is a cross sectional view of a disk-spindle motor in an IBM micro drive in accordance with the conventional art;

FIG. 2a is a cross sectional view of an ultra-slim disk-spindle motor in accordance with one preferred embodiment of the present invention;

FIG. 2b is a detailed view of the portion “A” in FIG. 2a;

FIG. 3a is a cross sectional view of an ultra-slim disk-spindle motor in accordance with another preferred embodiment of the present invention;

FIG. 3b is a detailed view of the portion “B” in FIG. 3a; and

FIG. 4 is a plan view of a prototype of an ultra-slim disk-spindle motor in accordance with the one preferred embodiment of the present invention.

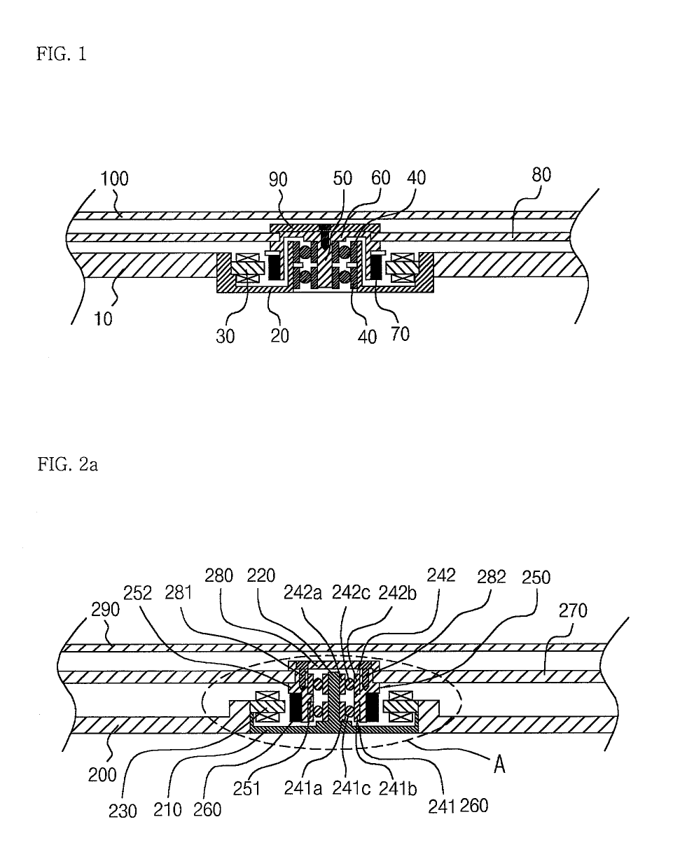

### DETAILED DESCRIPTION OF THE PREFERRED EMBODIMENT

Preferred embodiments of the present invention will now be described with reference to the accompanying drawings.

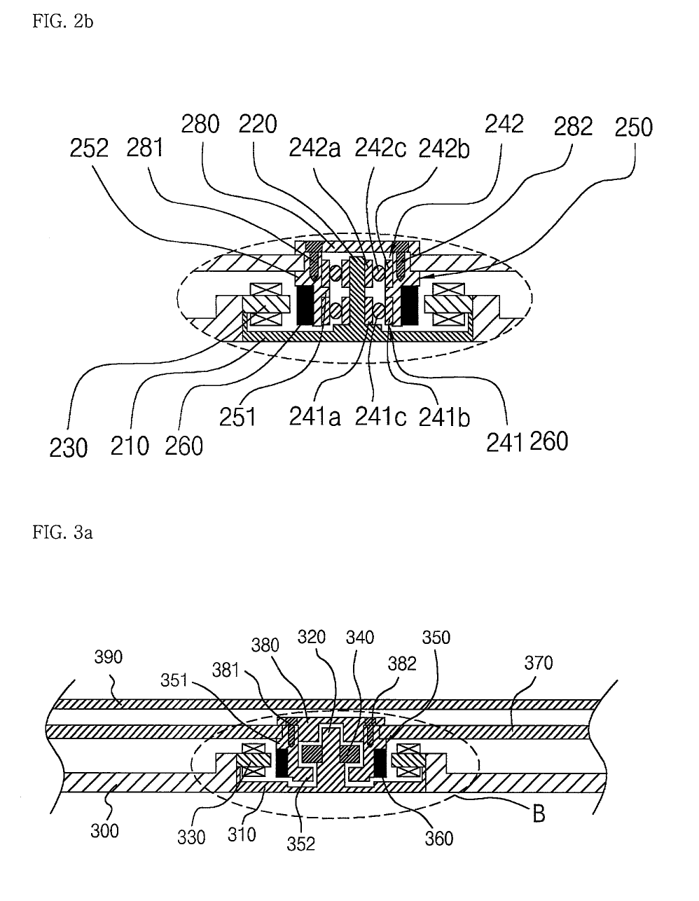

FIG. 2a is a cross sectional view of an ultra-slim disk-spindle motor in accordance with one preferred embodiment of the present invention and FIG. 2b is a detailed view of the portion “A” in FIG. 2a.

Referring to FIG. 2a and FIG. 2b, an ultra-slim disk-spindle motor largely includes a base plate 200, a housing 210, a fixed shaft 220, a stator 230, a lower ball bearing 241, an upper ball bearing 242, a hub 250, a permanent magnet 260, a disk 270, a clamp 280 and a cover 290.

The base plate 200 has a circular hole at a central portion of the base plate 200.

The housing 210 is formed integrally with the fixed shaft 220 and is vertically inserted at the circular hole of the base plate 200 and is fixed. Alternatively, the housing 210 is formed integrally with the base plate 200.

The stator 230 comprises a tooth-slot structured iron core and a winding wound around the core and is bonded to an upper side of an inner circumferential face of the circular hole of the base plate 200.

The lower ball bearing 241 is in a shape of a circular ring composed of an inner race 241a, an outer race 241b and multiple balls 241c and it is vertically bonded to a lower side of the fixed shaft 220.

The upper ball bearing 242 is also in a shape of a circular ring comprised of an inner race 242a, an outer race 242b and multiple balls 242c and it is vertically bonded to an upper side of the fixed shaft 220 spaced apart by a constant interval from the lower ball bearing 241.

The hub 250 is in a hollow cylindrical shape of which both ends are opened and has an inner protruding portion 251 at a central portion of an inner circumferential face thereof and an outer protruding portion 252 at an upper side of an outer circumferential face thereof. The inner protruding portion 251 is fixedly inserted between the outer race 241b of the lower ball bearing 241 and the outer race 242b of the upper ball bearing 242.

Further, the hub 250 serves as a yoke which forms a closed path of a magnetic flux and decreases a leakage.

The permanent magnet 260 is bonded to a lower side of the outer circumferential face of the outer protruding portion 252.

The disk 270 is vertically inserted and mounted on an upper side of the outer protruding portion 252 of the hub 250.

The clamp 280 is fixed on the hub 250 using a bolt 281 and 282 in order to mount the disk 270.

The cover 290 is fixed to the base plate 200 spaced apart by a certain interval from the upper side of the clamp 280.

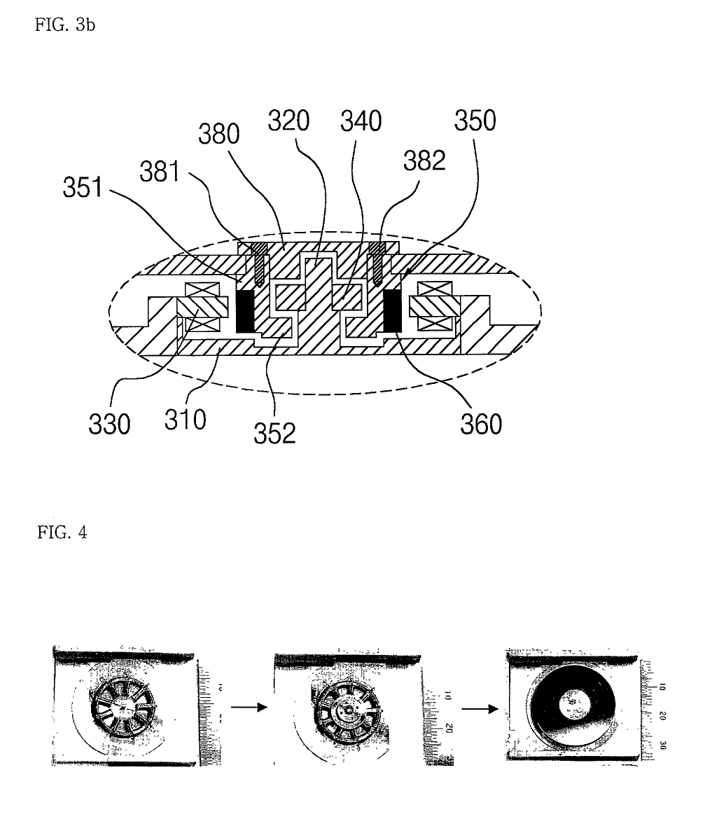

FIG. 3a is a cross sectional view of an ultra-slim disk-spindle motor in accordance with another preferred embodiment of the present invention and FIG. 3b is a detailed view of the portion “B” in FIG. 3a.

Referring to FIG. 3a and FIG. 3b, an ultra-slim disk-spindle motor largely includes a base plate 300, a housing 310, a fixed shaft 320, a stator 330, a thrust pad 340, a hub 350, a permanent magnet 360, a disk 370, a clamp 380 and a cover 390.

The base plate 300 has a circular hole at a central portion of the base plate 300.

The housing 310 is formed integrally with the fixed shaft 320 having a jaw portion at a central portion of an outer circumferential face thereof. The housing 310 is vertically inserted at the circular hole of the base plate 300 and is fixed. Alternatively, the housing 310 is formed integrally with the base plate 300.

The stator 330 comprises a tooth-slot structured iron core and a winding wound around the core and is bonded to an upper side of an inner circumferential face of the circular hole of the base plate 300.

The thrust pad 340 has a ring-shape and it is vertically inserted at the fixed shaft 320 and is mounted on the jaw portion of the fixed shaft 320.

The hub 350 is in a hollow cylindrical shape of which both ends are opened and has an outer protruding portion 351 at an upper side of an outer circumferential face thereof and an inner protruding portion 352 at a lower side of an inner circumferential face thereof. The inner protruding portion 352 is spaced apart by a constant interval from the thrust pad 340.

Further, the hub 350 serves as a yoke which forms a closed path of a magnetic flux and decreases a leakage.

The permanent magnet 360 is bonded to a lower side of the outer circumferential face of the outer protruding portion 351.

The disk 370 is vertically inserted and mounted on an upper side of the outer protruding portion 351 of the hub 350.

The clamp 380 is fixed with the hub 350 using a bolt 381 and 382 in order to mount the disk 370.

The cover 390 is fixed to the base plate 300 spaced apart by a certain interval from the upper side of the clamp 380.

FIG. 4 is a plan view of a prototype of the ultra-slim disk-spindle motor in accordance with one preferred embodiment of the present invention.

Referring to FIG. 4, a total thickness of the disk-spindle motor excepting the housing and cover is approximately 2.5 mm.

A main specification of the prototype of the ultra-thin disk-spindle motor is shown in table 1.

TABLE 1

| ITEM | DIMENSION | |
|---|---|---|
| INNER DIAMETER OF STATOR | 8.0 | mm |
| OUTER DIAMETER OF STATOR | 18.0 | mm |
| THICKNESS OF STATOR | 0.7 | mm |
| OUTER DIAMETER OF ROTOR | 7.6 | mm |
| INNER DIAMETER OF ROTOR | 3.0 | mm |
| THICKNESS OF AIR GAP | 0.2 | mm |
| HEIGHT OF PERMANENT MAGNET | 1.3 | mm |
| RESIDUAL MAGNETIC FLUX OF | 0.68 | T |
| PERMANENT MAGNET | | |
| NUMBER OF POLES OF PERMANENT | 12 | |
| MAGNET | | |
| NUMBER OF SLOTS | 9 | |

As described previously, an ultra-slim spindle motor for driving a disk of a micro drive is realized by removing an upper side of the hub of the spindle motor. This ultra-slim disk-spindle motor enables the micro drive to be manufactured in the type I of PCMCIA. Further, this ultra-slim spindle motor would be installed even at a personal digital assistant (PDA), a digital camera and so on.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An improved ultra-slim disk-spindle motor of the type having: a base plate 200 having a circular hole at a central portion thereof; a housing 210 fixedly inserted into the circular hole of the base plate; a fixed shaft 220 formed integrally with the housing at an upper central portion of the housing 210; a stator 230 bonded to an upper end portion of an inner circumferential face of the circular hole; a lower ball bearing 241 bonded to a lower side of an outer circumferential face of the fixed shaft 220, an upper ball bearing 242 spaced apart by a certain interval from the lower ball bearing 241 and bonded to an upper side of the outer circumferential face of the fixed shaft 220, wherein the improvement comprises:
a cylindrical hub 250 of which both ends are opened, the cylindrical hub having an inner protruding portion 251 formed along a central portion of an inner circumferential face of the hub and an outer protruding portion 252 formed along an upper side of the outer circumferential face of the hub, the inner protruding portion 251 being fixedly inserted between the lower ball bearing 241 and the upper ball bearing 242;
a permanent magnet 260 bonded to a lower side of an outer circumferential face of the outer protruding portion 252 of the hub 250;
a disk 270 mounted on an upper face of the inner protruding portion 252 of the hub 250; and
a clamp 280 fixed with the hub using a bolt 281 and 282 in order to mount the disk 270.

2. An improved ultra-slim disk-spindle motor of the type having: a base plate 300 having a circular hole at a central portion of the base plate; a housing 310 fixedly inserted into the circular hole of the base plate; a cylindrical fixed shaft 320 formed integrally with the housing at an upper central portion of the housing 310 and having a jaw portion at a central portion of an outer circumferential face of the housing; a stator 330 bonded to an upper end portion of an inner circumferential face of the circular hole of the base plate 300; a thrust pad 340 vertically inserted at the fixed shaft 320 and mounted on the jaw portion of the fixed shaft 320, wherein the improvement comprises:
a cylindrical hub 350 of which both ends are opened, the cylindrical hub 350 having an outer protruding portion 351 protruding from an upper side of an outer circumferential face of the hub and an inner protruding portion 352 protruding along a lower side of an inner circumferential face of the hub, the cylindrical hub spaced apart by a certain interval from the thrust pad 340;
a permanent magnet 360 bonded to a lower side of an outer circumferential face of the outer protruding portion 351 of the hub 350;
a disk 370 mounted on the outer protruding portion 351 of the hub 350; and
a clamp 380 fixed with the hub using a bolt 381 and 382 in order to mount the disk 370.
